(19) United States
(12) Patent Application Publication
(10) Pub. No.: US 2025/0091583 A1
(43) Pub. Date: Mar. 20, 2025

(54) STOP LINE POSITION ESTIMATION DEVICE

(71) Applicant: TOYOTA JIDOSHA KABUSHIKI KAISHA, Toyota -shi (JP)

(72) Inventor: Yuta IKEZAWA, Susono-shi, (JP)

(73) Assignee: TOYOTA JIDOSHA KABUSHIKI KAISHA, Toyota -shi (JP)

(21) Appl. No.: 18/731,786

(22) Filed: Jun. 3, 2024

(30) Foreign Application Priority Data
Sep. 19, 2023 (JP) 2023-150931

(51) Int. Cl. B60W 40/02

(52) U.S. Cl. CPC B60W 40/02; B60W 2552/53; B60W 2554/802

(57) ABSTRACT

A stop line position estimation device determines whether the target vehicle traffic light is a near-side traffic light installed on the near side of the target intersection or a far-side traffic light installed on the far-side of the target intersection from the positional relationship between the target object and the target vehicle traffic light, and when the target vehicle traffic light is a near-side traffic light, estimates a position located a predetermined first distance away from the near-side traffic light in the direction toward the host vehicle as a position of the target stop line, and when the target vehicle traffic light is a far-side traffic light, estimates a position located a predetermined second distance away from a far-side traffic light in the direction toward the host vehicle as a position of the target stop line, the predetermined second distance being longer than the predetermined first direction.

### CROSS-REFERENCE TO RELATED APPLICATION

This application claims priority to Japanese Patent Application No. 2023-150931 filed on Sep. 19, 2023, incorporated herein by reference in its entirety.

### BACKGROUND

### 1. Technical Field

The present disclosure relates to stop line position estimation devices.

### 2. Description of Related Art

There is known a deceleration assist device that detects a stop line using a camera image and assists in decelerating a host vehicle so that the host vehicle can reliably stop at the stop line. There is also known a stop line position estimation device that, when there is a stop line but the stop line cannot be detected using a camera image, detects a vehicle traffic light installed on the near side of an intersection using a camera image and estimates the position of the stop line from the position of the vehicle traffic light. The stop line position estimation device also detects a pedestrian traffic light using a camera image when a plurality of vehicle traffic lights is detected. The stop line position estimation device identifies a vehicle traffic light installed on the near side of the intersection from the position of the pedestrian traffic light, and estimates the position of the stop line from the position of the vehicle traffic light (see, for example, Japanese Unexamined Patent Application Publication No. 2021-33772 (JP 2021-33772 A)).

### SUMMARY

The above conventional stop line position estimation device identifies a vehicle traffic light installed on the near side of an intersection using the position of a pedestrian traffic light. Depending on the intersection, however, a vehicle traffic light may be installed only on the far side of the intersection. In this case, the conventional stop line position estimation device cannot identify a vehicle traffic light installed on the near side of the intersection, and as a result, cannot estimate the position of the stop line.

It is an object of the present disclosure to provide a stop line position estimation device that can estimate the position of a stop line not only when a vehicle traffic light is installed on the near side of an intersection, but also when a vehicle traffic light is installed only on the far side of an intersection.

A stop line position estimation device according to the present disclosure includes: a detection unit for detecting a target vehicle traffic light and a target object, the target vehicle traffic light being a vehicle traffic light that is installed at a target intersection and that regulates a host vehicle, the target intersection being an intersection located in front of the host vehicle in a direction of travel of the host vehicle, and the target object being an object other than the target vehicle traffic light and having a predetermined positional relationship with the target vehicle traffic light; and an estimation unit for estimating a position of a target stop line based on a position of the target vehicle traffic light, the target stop line being a stop line that regulates the host vehicle and that is provided on a near side of the target intersection so as to correspond to the target vehicle traffic light. The estimation unit is configured to determine, from the positional relationship between the target object and the target vehicle traffic light, whether the target vehicle traffic light is a near-side traffic light installed on the near side of the target intersection or a far-side traffic light installed on a far side of the target intersection. The estimation unit is configured to, when the target vehicle traffic light is the near-side traffic light, estimate a position that is a predetermined first distance away from the near-side traffic light in a direction toward the host vehicle as the position of the target stop line, and when the target vehicle traffic light is the far-side traffic light, estimate a position that is a predetermined second distance away from the far-side traffic light in the direction toward the host vehicle as the position of the target stop line, the predetermined second distance being greater than the predetermined first distance.

The stop line position estimation device according to the present disclosure can estimate the position of a stop line even when a vehicle traffic light is installed only on the far side of an intersection.

In the stop line position estimation device according to the present disclosure, the target object may be, for example, a target pedestrian traffic light that is a pedestrian traffic light installed at the target intersection so as to correspond to the target vehicle traffic light. In this case, the estimation unit may be configured to when the target vehicle traffic light is installed in a predetermined first range in the direction of travel of the host vehicle with respect to the target pedestrian traffic light, determine that the target vehicle traffic light is the far-side traffic light, and when the target vehicle traffic light is not installed in the predetermined first range and is installed a predetermined third distance away from the target pedestrian traffic light in the direction toward the host vehicle, determine that the target vehicle traffic light is the near-side traffic light. In this case, the predetermined first range may be a range from a position that is a predetermined fourth distance away from the target pedestrian traffic light in the direction toward the host vehicle to a position that is a predetermined fifth distance away from the target pedestrian traffic light in a direction away from the host vehicle.

The stop line position estimation device according to the present disclosure can determine, based on a pedestrian traffic light, whether a detected vehicle traffic light is a vehicle traffic light installed on the far side of an intersection.

In the stop line position estimation device according to the present disclosure, the estimation unit may be configured to, when a pedestrian traffic light detected by the detection unit is installed in a predetermined second range in the direction of travel of the host vehicle with respect to the target vehicle traffic light, determine that the pedestrian traffic light is the target pedestrian traffic light. In this case, the predetermined second range may be a range from a position that is a predetermined sixth distance away from the target vehicle traffic light in the direction toward the host vehicle to a position that is a predetermined seventh distance away from the target vehicle traffic light in the direction away from the host vehicle.

The stop line position estimation device according to the present disclosure can determine, based on a vehicle traffic light, whether a detected pedestrian traffic light is a pedestrian traffic light installed corresponding to the vehicle traffic light.

In the stop line position estimation device according to the present disclosure, the target object may be, for example, a target crossing vehicle that is a crossing vehicle that passes through the target intersection and that passes through the target intersection in a direction crossing the direction of travel of the host vehicle. In this case, the estimation unit may be configured to when the target vehicle traffic light is installed a predetermined eighth distance or more away from the target crossing vehicle in the direction away from the host vehicle, determine that the target vehicle traffic light is the far-side traffic light, and when the target vehicle traffic light is installed a predetermined ninth distance or more away from the target crossing vehicle in the direction toward the host vehicle, determine that the target vehicle traffic light is the near-side traffic light.

The stop line position estimation device according to the present disclosure can determine, based on a crossing vehicle, whether a detected vehicle traffic light is a vehicle traffic light installed on the far side of an intersection.

The components of the present disclosure are not limited to the embodiment of the present disclosure that will be described later with reference to the drawings. Other objects, other features, and accompanying advantages of the present disclosure will be readily understood from the description of the embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle driver assist device including a stop line position estimation device according to an embodiment of the present disclosure;

FIG. 2 is a diagram showing an intersection;

FIG. 3 is a flowchart illustrating a routine executed by the vehicle driver assist device according to the embodiment of the present disclosure;

FIG. 4 is a view similar to FIG. 2, showing a first distance range;

FIG. 5 is a view similar to FIG. 2, showing a first distance range;

FIG. 6 is a view similar to FIG. 2, showing a second distance range and a third near-side distance;

FIG. 7 is a view similar to FIG. 2, showing a fourth front distance and a fifth front distance;

FIG. 8 is a view similar to FIG. 2, showing a fourth near-side distance and a sixth near-side distance;

FIG. 9 is a flowchart illustrating a routine executed by the vehicle driver assist device according to the embodiment of the present disclosure;

FIG. 10 is a view similar to FIG. 2 and showing a seventh distance range;

FIG. 11 is a view similar to FIG. 2, showing a seventh distance range;

FIG. 12 is a view similar to FIG. 2 and showing the eighth far-side distance;

FIG. 13 is a view similar to FIG. 2 and showing a third front distance;

FIG. 14 is a view similar to FIG. 2, showing a third near-side distance and an 11th near-side distance;

FIG. 15 is a view similar to FIG. 2, showing a third near-side distance and an 11th near-side distance;

FIG. 16 is a view similar to FIG. 2, showing a fifth near-side distance and a twelfth near-side distance;

FIG. 17 is a view similar to FIG. 2, showing a fifth near-side distance and an 11th near-side distance;

FIG. 18 is a view similar to FIG. 2, showing a fifth near-side distance and an 11th near-side distance; and

FIG. 19 is a view similar to FIG. 2 and showing a sixth near-side distance.

### DETAILED DESCRIPTION OF EMBODIMENTS

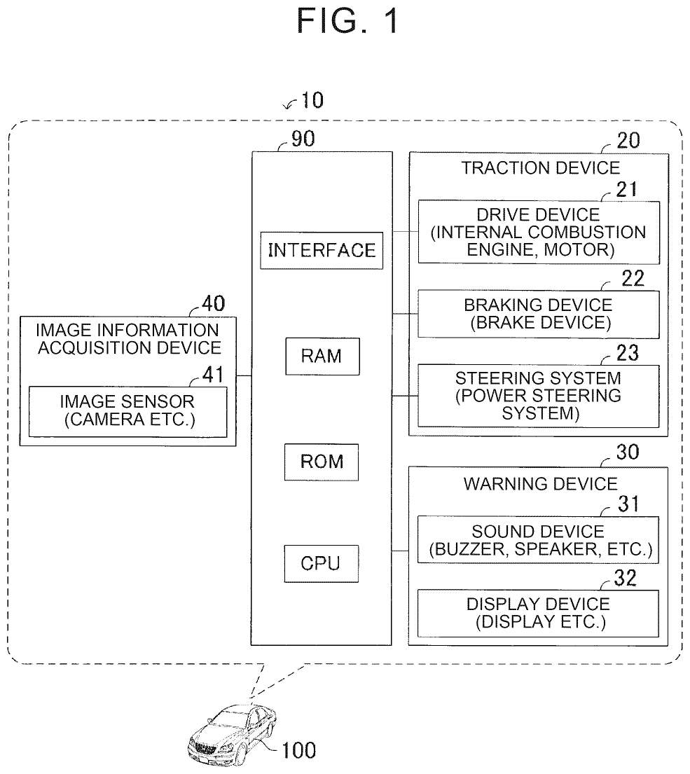

Hereinafter, a vehicle driver assist device including a stop line position estimation device according to an embodiment of the present disclosure will be described with reference to the drawings. FIG. 1 illustrates a vehicle driver assist device 10 according to an embodiment of the present disclosure. The vehicle driver assist device 10 is mounted on the host vehicle 100. Hereinafter, the vehicle driver assist device 10 will be described by taking as an example a case where an operator of the host vehicle 100 is a person who rides on the host vehicle 100 and drives the host vehicle 100 (that is, a driver of the host vehicle 100).

However, the operator of the host vehicle 100 may be a person who drives the host vehicle 100 remotely without getting on the host vehicle 100 (that is, a remote operator of the host vehicle 100). When the operator of the host vehicle 100 is a remote operator, the vehicle driver assist device 10 is mounted on the host vehicle 100 and a remote control facility installed outside the host vehicle 100 for remotely driving the host vehicle 100. The functions of the vehicle driver assist device 10 described below are shared by the vehicle driver assist device 10 mounted on the host vehicle 100 and the vehicle driver assist device 10 mounted on the remote control facility.

As illustrated in FIG. 1, the vehicle driver assist device 10 includes a control device and an ECU (electronic control device) 90 as an estimation unit. The ECU 90 includes a microcomputer as a main part. The microcomputer includes a storage medium such as a CPU, ROM, RAM and a non-volatile memory, an interface, and the like. CPU implements various functions by executing instructions, programs, or routines stored in a storage medium. In particular, in the present example, the vehicle driver assist device 10 stores, in a storage medium, a program for realizing various controls executed by the vehicle driver assist device 10.

In the present embodiment, the vehicle driver assist device 10 includes only one ECU 90, but may include a plurality of ECUs, and may be configured to share the functions of the vehicle driver assist device 10 described below by the respective ECUs.

Further, the vehicle driver assist device 10 may be configured to be able to update a program stored in the storage medium by wireless communication (for example, Internet communication) with an external device.

The host vehicle 100 is equipped with a traveling device 20, an alarm device 30, and an image information acquisition device 40.

The traveling device 20 includes a drive device 21, a braking device 22, and a steering device 23.

### Drive Device

The drive device 21 is a device that outputs a driving torque (driving force) applied to the host vehicle 100 in order to cause the host vehicle 100 to travel, and is, for example, an internal combustion engine, a motor, or the like. The drive device 21 is electrically connected to the ECU 90. The ECU 90 can control the driving torque output from the drive device 21 by controlling the operation of the drive device 21.

### Brake Device

The braking device 22 is a device that outputs a braking torque (braking force) applied to the host vehicle 100 in order to brake the host vehicle 100. The braking device 22 is electrically connected to the ECU 90. The ECU 90 can control the braking torque output from the braking device 22 by controlling the operation of the braking device 22.

### Steering Gear

The steering device 23 is a device that outputs a steering torque (steering force) applied to the host vehicle 100 in order to steer the host vehicle 100, and is, for example, a power steering device. The steering device 23 is electrically connected to the ECU 90. The ECU 90 can control the steering torque output from the steering device 23 by controlling the operation of the steering device 23.

### Warning Device

The alarm device 30 is a device that performs various types of notifications to the driver, and in the present example, includes a sound device 31 and a display device 32. The display device 32 is, for example, a display that displays various images. The sound device 31 is, for example, a buzzer for outputting various alarm sounds or a speaker for outputting various sounds.

### Sound Device

The sound device 31 is electrically connected to ECU 90. ECU 90 is capable of outputting various alarm sounds and sounds from the sound device 31.

### Display Device

The display device 32 is electrically connected to ECU 90. ECU 90 can cause the display device 32 to display various images.

### Image Information Acquisition Device

The image information acquisition device 40 is a device (detection unit in the present disclosure) that captures an image in front of the host vehicle 100, acquires an image in front of the host vehicle 100, and acquires data (image information IC) of the image. In the present example, the image information acquisition device 40 includes an image sensor 41. The image sensor 41 is, for example, a camera.

### Image Sensor

The image sensor 41 is electrically connected to ECU 90. The image sensor 41 captures an image in front of the host vehicle 100 to acquire an image in front of the host vehicle 100, and transmits data (image information IC) of the image to ECU 90.

### Operation of Vehicle Driver Assist Device

Next, the operation of the vehicle driver assist device 10 will be described.

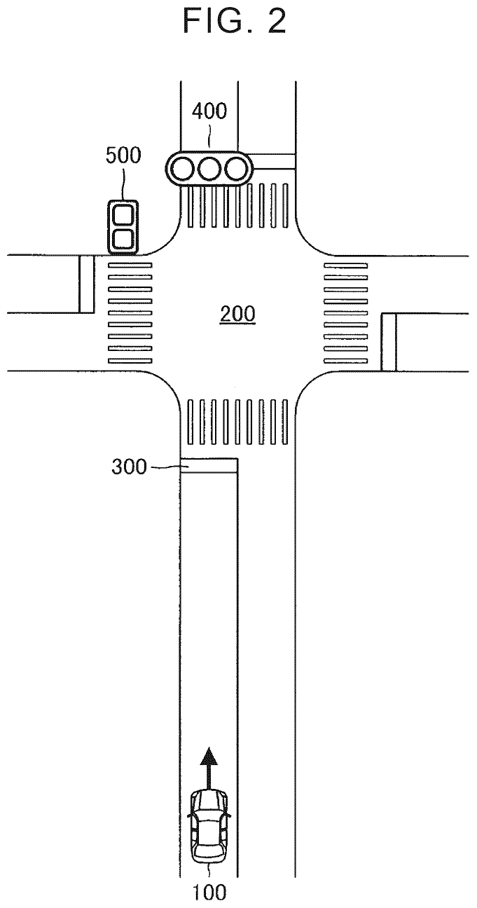

As illustrated in FIG. 2, the vehicle driver assist device 10 acquires the position of the target stop line 300 as the stop line position Pstop when approaching the target intersection 200, and executes the driver assist control based on the acquired stop line position Pstop.

The target intersection 200 is an intersection closest to the host vehicle 100 among the intersections in front of the host vehicle 100 in the direction of travel. The target stop line 300 is a stop line provided on the near side of the target intersection 200 and is a stop line that regulates the host vehicle 100.

Further, the driver assist control executed by the vehicle driver assist device 10 is, for example, automatic braking control, alarm control, or the like.

In the automatic braking control, for example, when the host vehicle 100 should stop before the target stop line 300 and the distance between the host vehicle 100 and the stop line position Pstop has decreased to a predetermined distance, the operation of the braking device 22 is controlled autonomously or automatically to add a braking force to the host vehicle 100 so that the host vehicle 100 stops before the target stop line 300.

In addition, the alarm control is a control for generating an alarm from the sound device 31 of the alarm device 30 indicating that the target stop line 300 is present when the distance between the host vehicle 100 and the stop line position Pstop becomes short to a predetermined distance. Alternatively, in the same case, the alarm control is a control of displaying an image indicating that the target stop line 300 is present by the display device 32 of the alarm device 30.

In the present specification, unless otherwise defined, the distance is a distance along the direction of travel of the host vehicle 100.

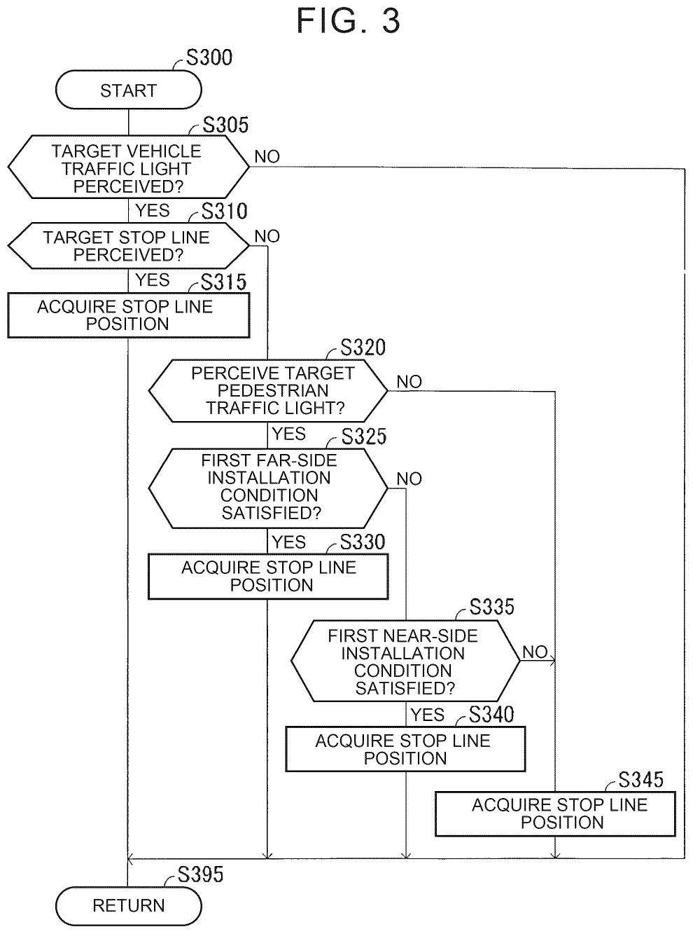

The vehicle driver assist device 10 acquires the stop line position Pstop when the predetermined condition is satisfied by executing the routine illustrated in FIG. 3 at a predetermined calculation cycle.

Further, as will be described later, the vehicle driver assist device 10 detects the target vehicle traffic light 400. The target vehicle traffic light 400 is a vehicle traffic light that is installed at the target intersection 200 that is an intersection located in front of the host vehicle 100 in the direction of travel of the host vehicle 100, and that regulates the host vehicle 100. The vehicle driver assist device 10 detects a target object (a target pedestrian traffic light 500 or a target crossing vehicle 600, which will be described later) that is a target object other than the target vehicle traffic light 400 and has a positional relationship that is determined in advance with the target vehicle traffic light 400. The vehicle driver assist device 10 estimates the position of the target stop line 300, which is a stop line that regulates the host vehicle 100 and is a stop line provided on the near side of the target intersection 200 so as to correspond to the target vehicle traffic light 400, based on the position of the target vehicle traffic light 400.

When the predetermined timing is reached, the vehicle driver assist device 10 starts the processing from S300 of the routine shown in FIG. 3, advances the processing to S305, and determines whether or not the target vehicle traffic light 400 is perceived. The target vehicle traffic light 400 is a vehicle traffic light closest to the host vehicle 100 among the vehicle traffic lights installed in front of the host vehicle 100 in the direction of travel, and is a vehicle traffic light that regulates the host vehicle 100. After the activation, the vehicle driver assist device 10 executes a process of perceiving the target vehicle traffic light 400 from the image-information IC at a predetermined calculation cycle.

When determining “Yes” in S305, the vehicle driver assist device 10 advances the process to S310 and determines whether or not the target stop line 300 is perceived. After the activation, the vehicle driver assist device 10 executes a process of perceiving the target stop line 300 from the image-information IC at a predetermined calculation cycle.

When determining “Yes” in S310, the vehicle driver assist device 10 advances the process to S315 and acquires the position of the perceived target stop line 300 as the stop line position Pstop. Next, the vehicle driver assist device 10 advances the processing to S395, and ends the processing of the routine once. The vehicle driver assist device 10 executes the driver assist control using the stop line position Pstop acquired by S315.

On the other hand, when S310 determines “No”, the vehicle driver assist device 10 advances the process to S320 and determines whether or not the target pedestrian traffic light 500 is perceived. After the activation, the vehicle driver assist device 10 executes a process of perceiving the target pedestrian traffic light 500 from the image-information IC at a predetermined calculation cycle.

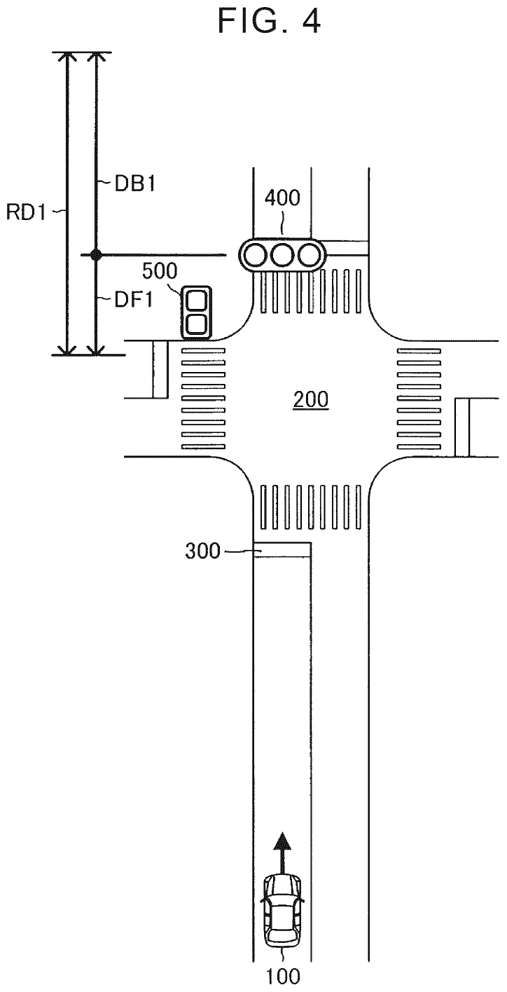

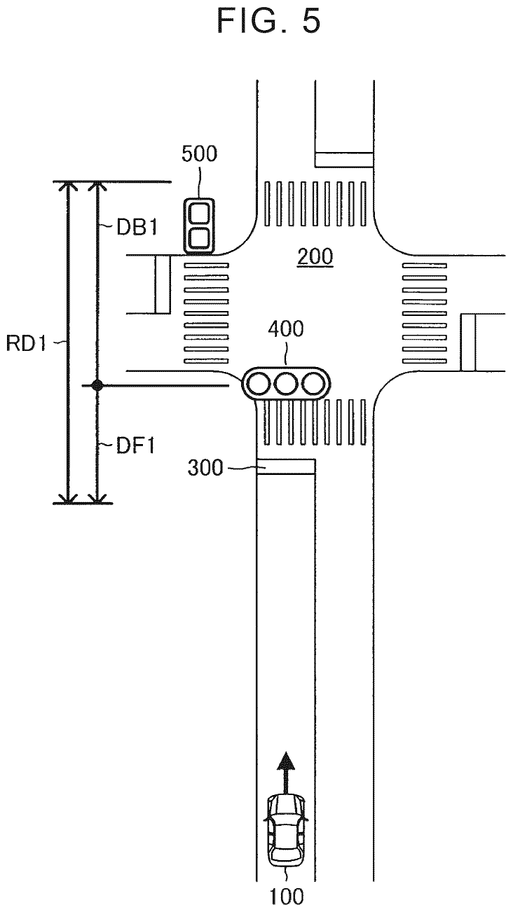

As illustrated in FIGS. 4 and 5, the target pedestrian traffic light 500 is a pedestrian traffic light installed in the first distance range RD1 with respect to the target vehicle traffic light 400 in the direction of travel of the host vehicle 100. In addition, the target pedestrian traffic light 500 is a pedestrian traffic light installed corresponding to the target vehicle traffic light 400. The pedestrian traffic light installed corresponding to the target vehicle traffic light 400 is a pedestrian traffic light installed for a pedestrian crossing an intersection in the same direction as the direction of travel of the host vehicle 100. Further, in the present specification, the pedestrian traffic light corresponding to the target vehicle traffic light 400 is a pedestrian traffic light installed corresponding to the target vehicle traffic light 400.

A pedestrian traffic light installed corresponding to a vehicle traffic light regulates a vehicle passing through an intersection is typically installed on the far side of the intersection in the direction of travel of the vehicle. Therefore, in the present example, it is assumed that the target pedestrian traffic light 500 is installed on the far side of the target intersection 200.

The first distance range RD1 is a predetermined second range in the present disclosure, and is a range determined in advance for determining whether the pedestrian traffic light perceived based on the image-information IC is the target pedestrian traffic light 500.

In particular, as illustrated in FIGS. 4 and 5, the first distance range RD1 is a range from the position located the first near-side distance DF1 before the target vehicle traffic light 400 (direction toward the host vehicle 100) to the position located the first far-side distance DB1 away from the target vehicle traffic light 400 (direction away from the host vehicle 100) in the direction of travel of the host vehicle 100.

The first near-side distance DF1 and the first far-side distance DB1 are a predetermined sixth distance and a predetermined seventh distance, respectively. Further, the first near-side distance DF1 and the first far-side distance DB1 are distances determined in advance for determining whether or not the pedestrian traffic light perceived based on the image-information IC is the target pedestrian traffic light 500.

In particular, the first near-side distance DF1 and the first far-side distance DB1 are each a predetermined distance. The first near-side distance DF1 and the first far-side distance DB1 are determined in advance so that, even if the target vehicle traffic light 400 is installed on the near side of the target intersection 200, the pedestrian traffic light installed corresponding to the target vehicle traffic light 400 is perceived as the target pedestrian traffic light 500. Further, the first near-side distance DF1 and the first far-side distance DB1 are determined in advance so that the pedestrian traffic light installed corresponding to the target vehicle traffic light 400 is perceived as the target pedestrian traffic light 500 even if it is installed on the far side of the target intersection 200.

As described above, in general, the pedestrian traffic lights installed corresponding to the vehicle traffic lights to be regulated in the vehicle passing through the intersection are installed on the far side of the intersection in the direction of travel of the vehicle. Therefore, the distance in the first far-side distance DB1 is longer than the first near-side distance DF1.

In the present embodiment, as the first near-side distance DF1, the first near-side distance corresponding to the size of the target intersection 200 is selected and used from the first near-side distance for each size of the intersection stored in the storage medium of the vehicle driver assist device 10.

The first near-side distance for each size of the intersection stored in the storage medium of the vehicle driver assist device 10 is obtained by a method or a statistical method described below. That is, for various intersections, data of the distance (first front distance) from the target vehicle traffic light installed on the far side of the intersection to the target pedestrian traffic light installed on the near side from the target vehicle traffic light is acquired. In consideration of the obtained distribution of the first near-side distance, an appropriate first near-side distance is determined for each size of the intersection. Alternatively, the first near-side distance for each size of the intersection is an average value of the first near-side distances acquired for each size of the intersection for the various intersections. Alternatively, the first near-side distance for each size of the intersection is a value obtained by adding 3σ to the average value of the first near-side distances obtained for each size of the intersection. Here, σ is a standard deviation in statistics.

Further, in the present embodiment, as the first far-side distance DB1, the first far-side distance corresponding to the size of the target intersection 200 is selected and used from the first far-side distance for each size of the intersection stored in the storage medium of the vehicle driver assist device 10.

The first far-side distance for each size of the intersection stored in the storage medium of the vehicle driver assist device 10 is acquired by a method similar to the above-described method or statistical method of acquiring the first near-side distance.

The first far-side distance DB1 is a distance equal to the intersection width W or a distance longer than the intersection width W by a predetermined distance. The intersection width W is the distance of the target intersection 200 in the direction of travel of the host vehicle 100.

The size of the target intersection 200 is acquired based on the image-information IC.

When determining “Yes” in S320, the vehicle driver assist device 10 advances the process to S325 and determines whether or not the first far-side installation-condition CB1 is satisfied. The first far-side installation condition CB1 is a condition that the target vehicle traffic light 400 is a traffic light (far-side traffic light) installed on the far side of the target intersection 200.

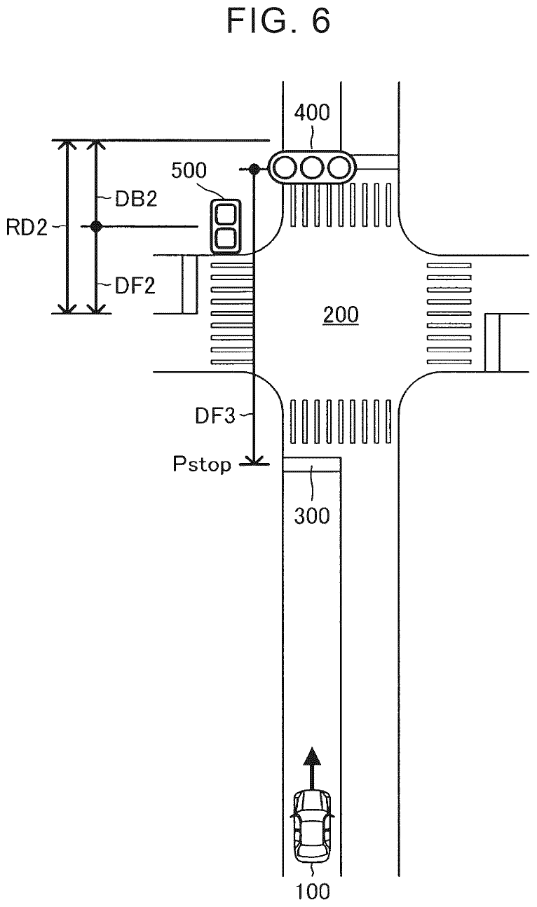

As illustrated in FIG. 6, in the present embodiment, when the target vehicle traffic light 400 is installed in the second distance range RD2 with respect to the target pedestrian traffic light 500, the first far-side installation condition CB1 is satisfied. Therefore, when the absolute value of the traffic light distance difference ΔDS is equal to or less than the predetermined traffic light distance difference ΔDSth, the first far-side installation condition CB1 is satisfied.

The traffic light distance difference ΔDS is obtained by subtracting the vehicle traffic light distance DVS from the pedestrian traffic light distance DPS (ΔDS=DPS−DVS). The pedestrian traffic light distance DPS is a distance between the host vehicle 100 and the target pedestrian traffic light 500. The vehicle traffic light distance DVS is a distance between the host vehicle 100 and the target vehicle traffic light 400.

The second distance range RD2 is a predetermined first range in the present disclosure, and is a range determined in advance for determining whether the target vehicle traffic light 400 is installed on the far side of the target intersection 200.

In particular, as illustrated in FIG. 6, the second distance range RD2 is a range from the position located the second near-side distance DF2 before the target pedestrian traffic light 500 to the position located the second far-side distance DB2 on the far side from the target pedestrian traffic light 500 in the direction of travel of the host vehicle 100.

The second near-side distance DF2 and the second far-side distance DB2 are a predetermined fourth distance and a predetermined fifth distance, respectively. Further, the second near-side distance DF2 and the second far-side distance DB2 are respectively predetermined distances for determining whether or not the target vehicle traffic light 400 is a traffic light installed on the far side of the target intersection 200.

In particular, the second near-side distance DF2 and the second far-side distance DB2 are predetermined distances such that, when the target vehicle traffic light 400 is installed on the far side of the target intersection 200, it is determined that the target vehicle traffic light 400 is installed in the second distance range RD2 with respect to the target pedestrian traffic light 500.

In the present embodiment, as the second near-side distance DF2 and the second far-side distance DB2, the second near-side distance and the second far-side distance corresponding to the size of the target intersection 200 are selected and used from the second near-side distance and the second far-side distance for each size of the intersection stored in the storage medium of the vehicle driver assist device 10, respectively.

The second near-side distance and the second far-side distance for each size of the intersection stored in the storage medium of the vehicle driver assist device 10 are acquired by a method similar to the method or statistical method of acquiring the first near-side distance described above, respectively.

The second near-side distance DF2 and the second far-side distance DB2 may be the same distance or may be different distances from each other. Further, when the second near-side distance DF2 and the second far-side distance DB2 are equal distances, the predetermined traffic light distance difference ΔDSth is equal to the second near-side distance DF2 and the second far-side distance DB2.

The second far-side distance DB2 is a distance shorter than the first far-side distance DB1. Further, in the present embodiment, the second near-side distance DF2 is a distance equal to the first near-side distance DF1, but may be a distance that differs from the first near-side distance DF1. However, the second near-side distance DF2 is a distance shorter than the fourth near-side distance DF4 described later.

When it is determined as “Yes” in S325, the vehicle driver assist device 10 advances the process to S330, and as shown in FIG. 6, acquires the position located the third near-side distance DF3 before the target vehicle traffic light 400 as the stop line position Pstop. Next, the vehicle driver assist device 10 advances the processing to S395, and ends the processing of the routine once. Here, the vehicle driver assist device 10 executes various driver assist controls using the stop line position Pstop acquired by S330.

The third near-side distance DF3 is a predetermined second distance. The third near-side distance DF3 is a predetermined distance for estimating the stop line position Pstop from the position of the target vehicle traffic light 400 when the target vehicle traffic light 400 is installed on the far side of the target intersection 200.

In the present embodiment, as the third near-side distance DF3, the third near-side distance corresponding to the size of the target intersection 200 is selected and used from the third near-side distance for each size of the intersection stored in the storage medium of the vehicle driver assist device 10.

The third near-side distance for each size of the intersection stored in the storage medium of the vehicle driver assist device 10 is a distance obtained by a method or a statistical method described below. That is, for the various intersections, the data of the distance (third near-side distance) between the target vehicle traffic light and the target stop line installed on the far side of the intersection is acquired. An appropriate third near-side distance is determined for each size of the intersection by considering the acquired distribution of the third near-side distances for each size of the intersection. Alternatively, the third near-side distance for each size of the intersection is an average value of the third near-side distances acquired for each size of the intersection for the various intersections.

On the other hand, when S325 determines “No”, the vehicle driver assist device 10 advances the process to S335 and determines whether or not the first near-side installation condition CF1 is satisfied. The first near-side installation condition CF1 is a condition that the target vehicle traffic light 400 is a traffic light (near-side traffic light) installed on the near side of the target intersection 200.

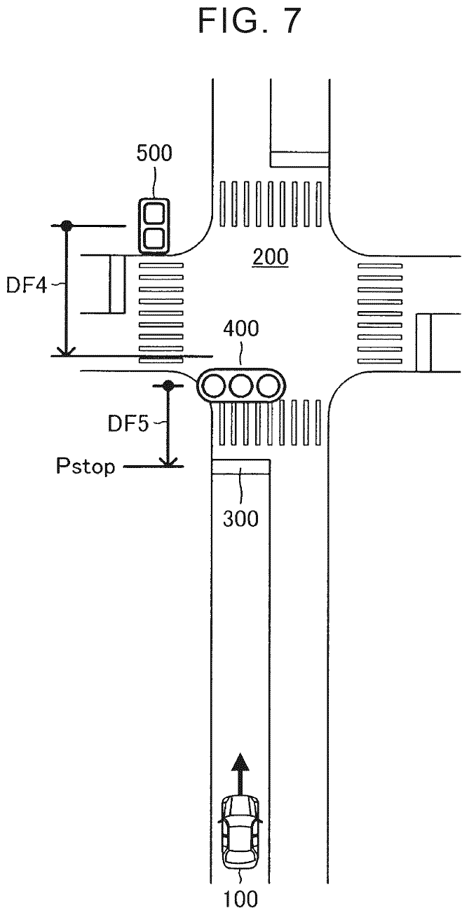

As illustrated in FIG. 7, in the present embodiment, when the target vehicle traffic light 400 is installed the fourth near-side distance DF4 or more on the near side from the target pedestrian traffic light 500, the first near-side installation condition CF1 is satisfied. Therefore, when the distance between the target vehicle traffic light 400 and the target pedestrian traffic light 500 is larger than the fourth near-side distance DF4, the first near-side installation condition CF1 is established.

The fourth near-side distance DF4 is a predetermined third distance in the present disclosure, and is a predetermined distance for determining whether or not the target vehicle traffic light 400 is a traffic light installed on the near side of the target intersection 200.

In particular, the fourth near-side distance DF4 is a predetermined distance such that, when the target vehicle traffic light 400 is installed on the near side of the target intersection 200, it is determined that the target vehicle traffic light 400 is installed the fourth near-side distance DF4 or more on the near side from the target pedestrian traffic light 500.

In the present embodiment, as the fourth near-side distance DF4, the fourth near-side distance corresponding to the size of the target intersection 200 is selected and used from the fourth near-side distance for each size of the intersection stored in the storage medium of the vehicle driver assist device 10.

The fourth near-side distance for each size of the intersection stored in the storage medium of the vehicle driver assist device 10 is acquired by a method similar to the method or the statistical method of acquiring the first near-side distance described above.

The fourth near-side distance DF4 is larger than the second near-side distance DF2.

When it is determined as “Yes” in S335, the vehicle driver assist device 10 advances the process to S340, and as shown in FIG. 7, acquires the front position from the target vehicle traffic light 400 by the fifth near-side distance DF5 as the stop line position Pstop. Next, the vehicle driver assist device 10 advances the processing to S395, and ends the processing of the routine once. The vehicle driver assist device 10 executes the driver assist control using the stop line position Pstop acquired by S340.

The fifth near-side distance DF5 is a predetermined first distance. The fifth near-side distance DF5 is a predetermined distance for estimating the stop line position Pstop from the position of the target vehicle traffic light 400 when the target vehicle traffic light 400 is installed on the near side of the target intersection 200.

In the present embodiment, as the fifth near-side distance DF5, the fifth near-side distance corresponding to the size of the target intersection 200 is selected and used from the fifth near-side distance for each size of the intersection stored in the storage medium of the vehicle driver assist device 10.

The fifth near-side distance for each size of the intersection stored in the storage medium of the vehicle driver assist device 10 is acquired by a method similar to the method or the statistical method of acquiring the third near-side distance described above.

The fifth near-side distance DF5 is a distance shorter than the third near-side distance DF3.

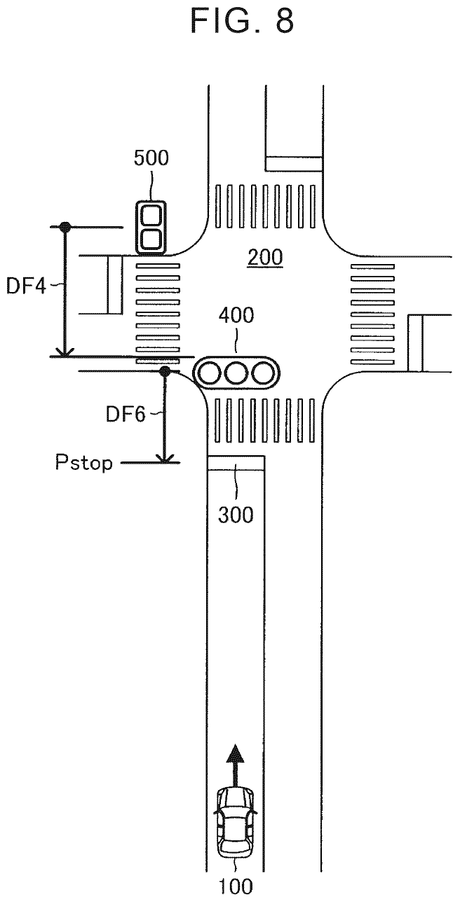

On the other hand, when it is determined that the vehicle driver assist device 10 is “No” in S335, the process proceeds to S345, and as shown in FIG. 8, the position of the front from the target vehicle traffic light 400 by the sixth near-side distance DF6 is acquired as the stop line position Pstop. Next, the vehicle driver assist device 10 advances the processing to S395, and ends the processing of the routine once. The vehicle driver assist device 10 executes the driver assist control using the stop line position Pstop acquired by S345.

The sixth near-side distance DF6 is a predetermined distance for estimating the stop line position Pstop from the position of the target vehicle traffic light 400 when it cannot be determined whether the target vehicle traffic light 400 is installed on the far side of the target intersection 200 or on the near side of the target intersection 200.

The sixth near-side distance DF6 is an appropriate distance that is at least larger than the third near-side distance DF3 and smaller than the fifth near-side distance DF5.

Also, when S320 determines “No”, the vehicle driver assist device 10 advances the process to S345 and acquires the position that is the sixth near-side distance DF6 before the target vehicle traffic light 400 as the stop line position Pstop. Next, the vehicle driver assist device 10 advances the processing to S395, and ends the processing of the routine once. Again, the vehicle driver assist device 10 executes the driver assist control using the stop line position Pstop acquired by S345.

When S305 determines “No”, the vehicle driver assist device 10 directly advances the processing to S395, and ends the processing of this routine once.

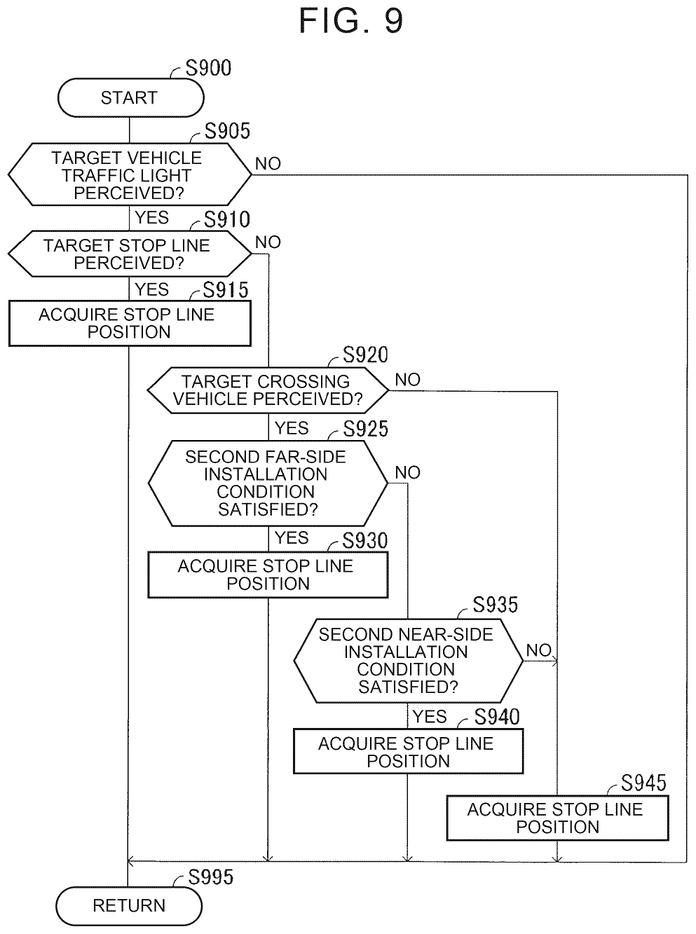

Further, the vehicle driver assist device 10 acquires the stop line position Pstop when the predetermined condition is satisfied by executing the routine illustrated in FIG. 9 at a predetermined calculation cycle.

When the predetermined timing is reached, the vehicle driver assist device 10 starts the processing from S900 of the routine shown in FIG. 9, advances the processing to S905, and determines whether or not the target vehicle traffic light 400 is perceived.

When determining “Yes” in S905, the vehicle driver assist device 10 advances the process to S910 and determines whether or not the target stop line 300 is perceived.

When determining “Yes” in S910, the vehicle driver assist device 10 advances the process to S915 and acquires the position of the perceived target stop line 300 as the stop line position Pstop. Next, the vehicle driver assist device 10 advances the processing to S995, and ends the processing of the routine once. The vehicle driver assist device 10 executes the driver assist control using the stop line position Pstop acquired by S915.

On the other hand, when S910 determines “No”, the vehicle driver assist device 10 advances the process to S920 and determines whether or not the target crossing vehicle 600 is perceived. The vehicle driver assist device 10 executes a process of perceiving the target crossing vehicle 600 from the image-information IC at a predetermined calculation cycle.

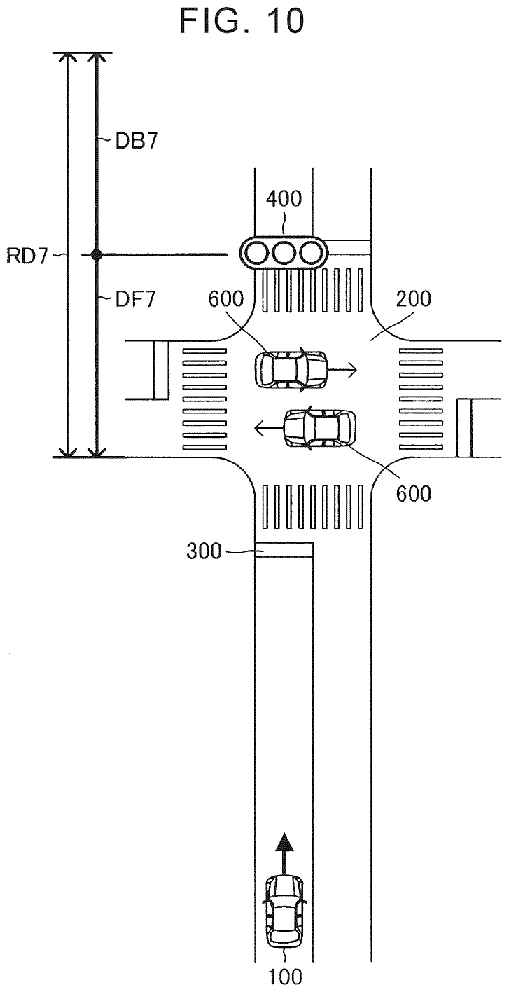

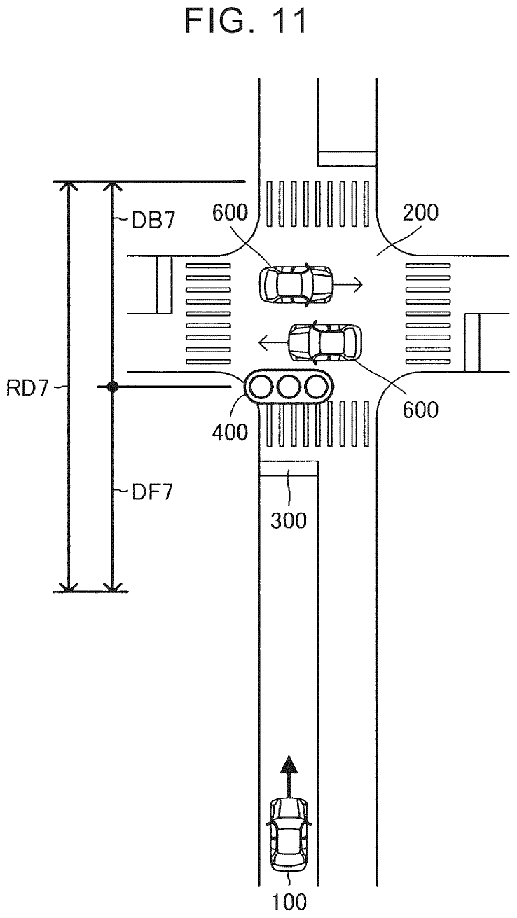

As illustrated in FIGS. 10 and 11, the target crossing vehicle 600 is a vehicle (crossing vehicle) traveling at the target intersection 200 in a direction crossing (in particular, perpendicular to) the direction of travel of the host vehicle 100. Further, the target crossing vehicle 600 is a vehicle that travels in the seventh distance range RD7 from the target vehicle traffic light 400.

The seventh distance range RD7 is a predetermined range for determining whether the vehicle perceived based on the image-information IC is the target crossing vehicle 600.

In particular, as shown in FIGS. 10 and 11, the seventh distance range RD7 is a range from the position located the seventh near-side distance DF7 before the target vehicle traffic light 400 (direction toward the host vehicle 100) to the position located the seventh far-side distance DB7 away from the target vehicle traffic light 400 (direction away from the host vehicle 100) in the direction of travel of the host vehicle 100.

The seventh near-side distance DF7 and the seventh far-side distance DB7 are distances determined in advance for determining whether the vehicle perceived based on the image-information IC is the target crossing vehicle 600.

In particular, the seventh near-side distance DF7 and the seventh far-side distance DB7 are predetermined distances such that, even if the target vehicle traffic light 400 is installed on the near side of the target intersection 200 or is installed on the far side of the target intersection 200, the vehicle passing through the target intersection 200 in the direction crossing the direction of travel of the host vehicle 100 is perceived as the target crossing vehicle 600.

In the present embodiment, as the seventh near-side distance DF7, the seventh near-side distance which is assumed to be the size of the target intersection 200 is selected and used from the seventh near-side distance for each size of the intersection stored in the storage medium of the vehicle driver assist device 10.

The seventh near-side distance for each size of the intersection stored in the storage medium of the vehicle driver assist device 10 is a distance obtained by a method or a statistical method described below. That is, for the various intersections, data of the distance (the seventh front distance) between the target vehicle traffic light installed on the far side of the intersection and the boundary on the near side of the intersection is acquired.

In consideration of the obtained distribution of the seventh near-side distance, an appropriate seventh near-side distance is determined for each size of the intersection. Alternatively, the seventh near-side distance for each size of the intersection is an average value of the seventh near-side distances acquired for each size of the intersection for the various intersections. Alternatively, the seventh near-side distance for each size of the intersection is a value obtained by adding 3σ to the average value of the seventh near-side distances obtained for each size of the intersection. Here, σ is a standard deviation in statistics.

Further, in the present embodiment, as the seventh far-side distance DB7, the seventh far-side distance corresponding to the size of the target intersection 200 is selected and used from the seventh far-side distance for each size of the intersection stored in the storage medium of the vehicle driver assist device 10.

The seventh far-side distance for each size of the intersection stored in the storage medium of the vehicle driver assist device 10 is acquired by a method similar to the above-described method or statistical method of acquiring the seventh near-side distance.

The seventh near-side distance DF7 and the seventh far-side distance DB7 are each a distance equal to the intersection width W or a distance longer than the intersection width W by a predetermined distance.

When determining “Yes” in S920, the vehicle driver assist device 10 advances the process to S925 and determines whether or not the second far-side installation-condition CB2 is satisfied. The second far-side installation condition CB2 is a condition that the target vehicle traffic light 400 is a traffic light (far-side traffic light) installed on the far side of the target intersection 200.

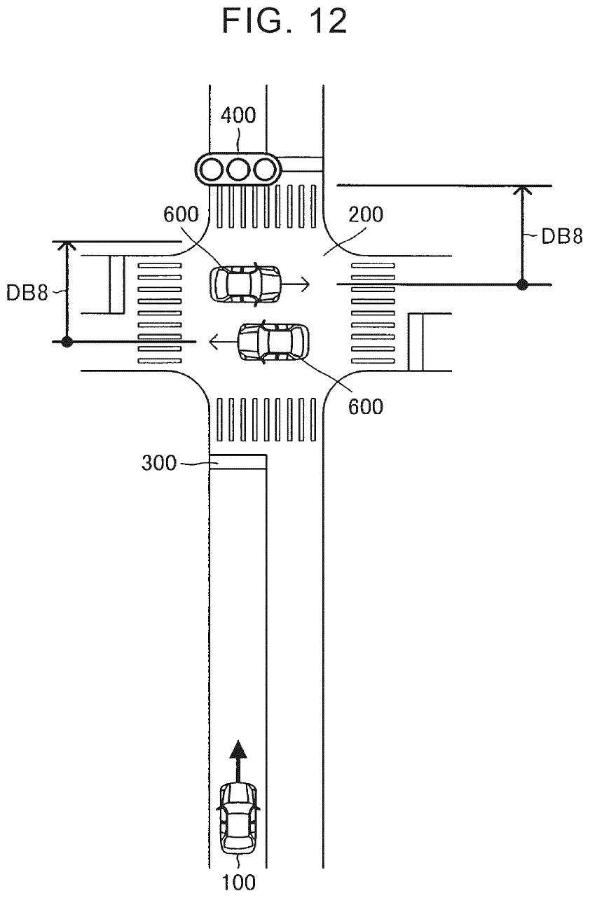

As illustrated in FIG. 12, in the present embodiment, when the target vehicle traffic light 400 is installed the eighth far-side distance DB8 or more on the far side from the target crossing vehicle 600, the second far-side installation condition CB2 is satisfied. Therefore, when the crossing vehicle distance difference ΔDCV is positive and is equal to or larger than the eighth far-side distance DB8, the second far-side installation condition CB2 is satisfied.

The crossing vehicle distance difference ΔDCV is a value obtained by subtracting the crossing vehicle distance DCV from the vehicle traffic light distance DVS (ΔDCV=DVS−DCV). The vehicle traffic light distance DVS is a distance between the host vehicle 100 and the target vehicle traffic light 400. The crossing vehicle distance DCV is a distance between the host vehicle 100 and the target crossing vehicle 600.

The eighth far-side distance DB8 is a predetermined eighth distance in the present disclosure, and is a predetermined distance for determining whether or not the target vehicle traffic light 400 is installed on the far side of the target intersection 200.

In particular, the eighth far-side distance DB8 is a predetermined distance such that, when the target vehicle traffic light 400 is installed on the far side of the target intersection 200, it is determined that the target vehicle traffic light 400 is installed the eighth far-side distance DB8 or more on the far side from the target crossing vehicle 600.

In the present embodiment, as the eighth far-side distance DB8, the eighth far-side distance corresponding to the size of the target intersection 200 is selected and used from the eighth far-side distance for each size of the intersection stored in the storage medium of the vehicle driver assist device 10.

The eighth far-side distance for each size of the intersection stored in the storage medium of the vehicle driver assist device 10 is acquired by a method similar to the above-described method or statistical method of acquiring the seventh near-side distance.

The eighth far-side distance DB8 is a distance shorter than the seventh near-side distance DF7 and the seventh far-side distance DB7.

Further, in the present embodiment, it may be determined whether or not the second far-side installation condition CB2 is satisfied depending on whether the target crossing vehicle 600 is a vehicle traveling on the near side of the target intersection 200 or a vehicle traveling on the far side of the target intersection 200.

In this case, in a case where the target crossing vehicle 600 is a crossing vehicle traveling on the near side of the target intersection 200, when the target vehicle traffic light 400 is installed by the ninth far-side distance DB9 or more on the far side from the target crossing vehicle 600, the second far-side installation condition CB2 is satisfied. Alternatively, when the target crossing vehicle 600 is a crossing vehicle traveling on the far side of the target intersection 200, the second far-side installation condition CB2 is satisfied when the target vehicle traffic light 400 is installed the tenth far-side distance DB10 or more on the far side from the target crossing vehicle 600.

Therefore, when the target crossing vehicle 600 is a vehicle traveling on the near side of the target intersection 200, the second far-side installation condition CB2 is established when the crossing vehicle distance difference ΔDCV is positive and is equal to or larger than the ninth far-side distance DB9. When the target crossing vehicle 600 is a vehicle traveling on the far side of the target intersection 200, the second far-side installation condition CB2 is satisfied when the crossing vehicle distance difference ΔDCV is positive and is equal to or larger than the tenth far-side distance DB10.

The ninth far-side distance DB9 is a predetermined distance for determining whether the target vehicle traffic light 400 is installed on the far side of the target intersection 200 when the target crossing vehicle 600 is a vehicle traveling on the near side of the target intersection 200. Further, the tenth far-side distance DB10 is a predetermined distance for determining whether the target vehicle traffic light 400 is installed on the far side of the target intersection 200 when the target crossing vehicle 600 is a vehicle traveling on the far side of the target intersection 200.

In particular, the ninth far-side distance DB9 and the tenth far-side distance DB10 are predetermined distances so that, when the target vehicle traffic light 400 is installed on the far side of the target intersection 200, it is determined that the target vehicle traffic light 400 is installed on the far side of the target intersection 200.

In the present embodiment, as the ninth far-side distance DB9 and the tenth far-side distance DB10, the ninth far-side distance and the tenth far-side distance corresponding to the size of the target intersection 200 are selected and used from the ninth far-side distance and the tenth far-side distance for each size of the intersection stored in the storage medium of the vehicle driver assist device 10, respectively.

The ninth far-side distance and the tenth far-side distance for each size of the intersection stored in the storage medium of the vehicle driver assist device 10 are acquired by a method similar to the above method or statistical method of acquiring the seventh near-side distance.

Whether the target crossing vehicle 600 is a vehicle traveling on the near side of the target intersection 200 or a vehicle traveling on the far side of the target intersection 200 is determined based on the image-information IC.

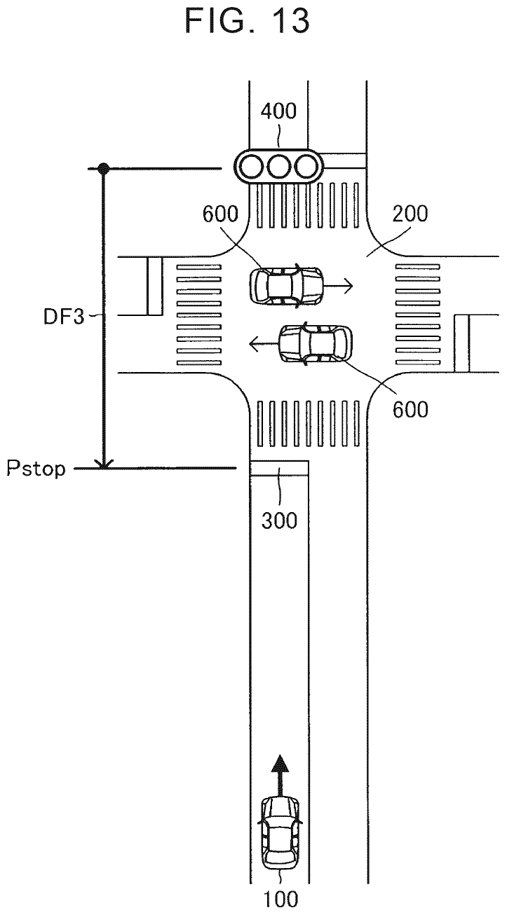

When it is determined as “Yes” in S925, the vehicle driver assist device 10 advances the process to S930 and acquires, as shown in FIG. 13, the front position from the target vehicle traffic light 400 by the third near-side distance DF3 as the stop line position Pstop. Next, the vehicle driver assist device 10 advances the processing to S995, and ends the processing of the routine once. Here, the vehicle driver assist device 10 executes various driver assist controls using the stop line position Pstop acquired by S930.

The third near-side distance DF3 is the third near-side distance selected according to the size of the target intersection 200 as described above.

In S930, the vehicle driver assist device 10 compares the position located the third near-side distance DF3 before the target vehicle traffic light 400 with the position located the 11th near-side distance DF11 before the target crossing vehicle 600 in the direction of travel of the host vehicle 100. As a result of the comparison, the vehicle driver assist device 10 may be configured to acquire a closer position (position closer to the host vehicle 100) as the stop line position Pstop.

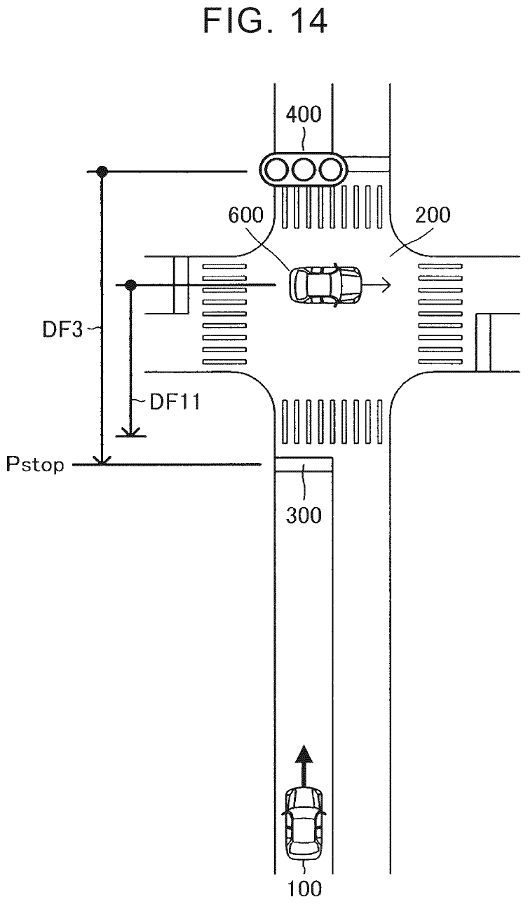

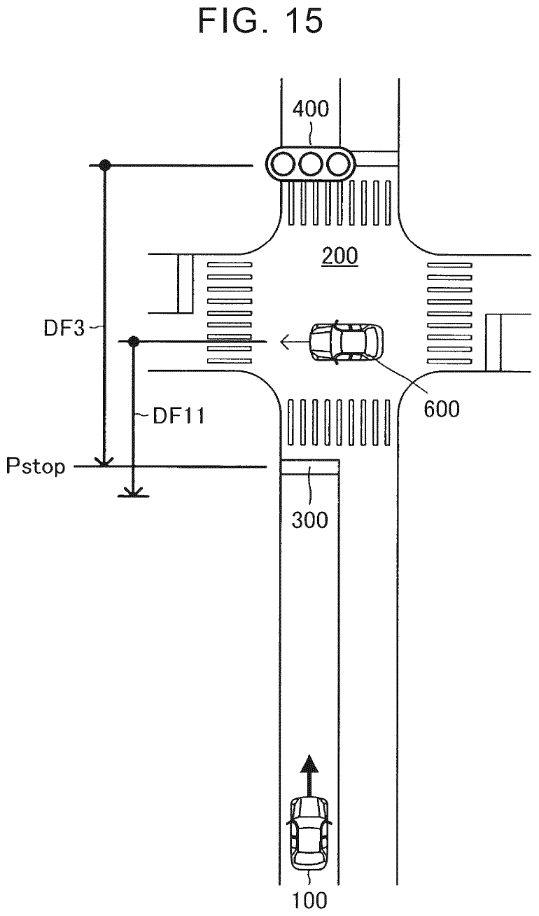

That is, as shown in FIG. 14, in the direction of travel of the host vehicle 100, than the position of the front by the 11th near-side distance DF11 from the target crossing vehicle 600, the position of the front by the third near-side distance DF3 from the target vehicle traffic light 400, than the front position (the position closer to the host vehicle 100), the target vehicle traffic light 400 the position of the front by the third near-side distance DF3 may be acquired as a stop line position Pstop. As shown in FIG. 15, in the direction of travel of the host vehicle 100, than the position before only the third near-side distance DF3 from the target vehicle traffic light 400, the position before only the 11th front distance DF11 from the target crossing vehicle 600, if the position before the position (closer to the host vehicle 100) is, the position before only the 11th front distance DF11 from the target crossing vehicle 600 may be acquired as a stop line position Pstop.

The 11th near-side distance DF11 is a predetermined distance for estimating the stop line position Pstop from the position of the target crossing vehicle 600 traveling on the near side of the target intersection 200.

In the present embodiment, as the 11th near-side distance DF11, the 11th near-side distance corresponding to the size of the target intersection 200 is selected and used from the 11th near-side distance for each size of the intersection stored in the storage medium of the vehicle driver assist device 10.

The 11th near-side distance for each size of the intersection stored in the storage medium of the vehicle driver assist device 10 is obtained by a method or a statistical method described below. That is, for the various intersections, data of the distance (11th near-side distance) between the target crossing vehicle traveling on the near side of the intersection and the stop line position is acquired. In consideration of the obtained distribution of the 11th near-side distances, an appropriate 11th near-side distance is determined for each size of the target intersection. Alternatively, the 11th near-side distance for each size of the intersection is an average value of the 11th near-side distances acquired for each size of the intersection for the various intersections.

The 11th near-side distance DF11 is a distance shorter than the third near-side distance DF3.

On the other hand, when S925 determines “No”, the vehicle driver assist device 10 advances the process to S935 and determines whether or not the second near-side installation-condition CF2 is satisfied. The second near-side installation condition CF2 is a condition that the target vehicle traffic light 400 is a traffic light (near-side traffic light) installed on the near side of the target intersection 200.

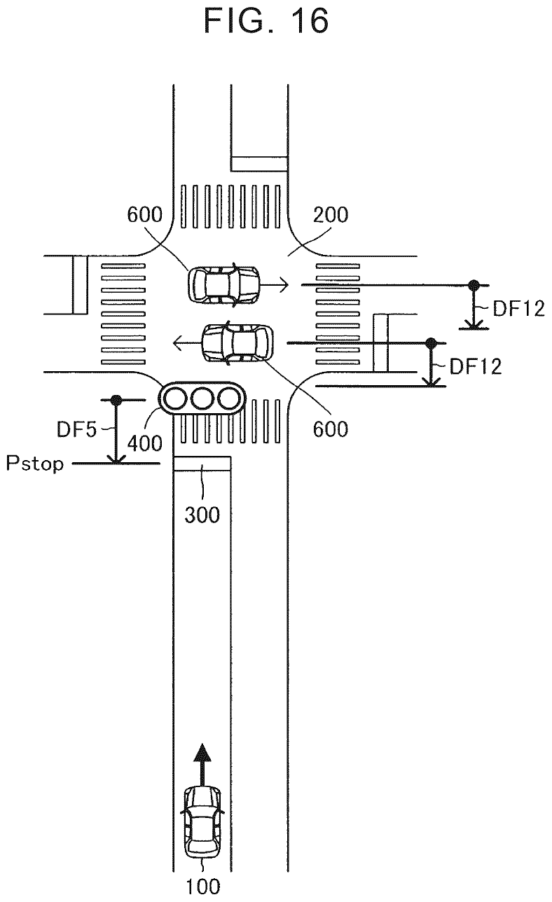

As illustrated in FIG. 16, in the present embodiment, when the target vehicle traffic light 400 is installed the twelfth near-side distance DF12 or more on the near side from the target crossing vehicle 600, the second near-side installation condition CF2 is satisfied. Therefore, when the crossing vehicle distance difference ΔDCV is a negative value and the absolute value of the crossing vehicle distance difference ΔDCV is equal to or greater than the twelfth near-side distance DF12, the second near-side installation condition is satisfied.

The twelfth near-side distance DF12 is a predetermined ninth distance in the present disclosure, and is a predetermined distance for determining whether the target vehicle traffic light 400 is installed on the near side of the target intersection 200.

In particular, the twelfth near-side distance DF12 is a predetermined distance such that, when the target vehicle traffic light 400 is installed on the near side of the target intersection 200, it is determined that the target vehicle traffic light 400 is installed the twelfth near-side distance DF12 or more on the near side from the target crossing vehicle 600.

In the present embodiment, as the twelfth near-side distance DF12, the twelfth near-side distance corresponding to the size of the target intersection 200 is selected and used from the twelfth near-side distance for each size of the intersection stored in the storage medium of the vehicle driver assist device 10.

The twelfth near-side distance for each size of the intersection stored in the storage medium of the vehicle driver assist device 10 is a distance obtained by a method similar to the above-described method or statistical method of obtaining the seventh near-side distance.

The twelfth near-side distance DF12 is a distance shorter than the seventh near-side distance DF7.

In addition, when the target crossing vehicle 600 is a crossing vehicle traveling on the near side of the target intersection 200, the second near-side installation condition CF2 may be established when the target vehicle traffic light 400 is installed the thirteenth near-side distance DF13 or more on the near side from the target crossing vehicle 600. Alternatively, when the target crossing vehicle 600 is a crossing vehicle traveling on the far side of the target intersection 200, the second near-side installation condition CF2 may be established when the target vehicle traffic light 400 is installed the fourteenth near-side distance DF14 or more on the near side from the target crossing vehicle 600.

The thirteenth near-side distance DF13 and the fourteenth near-side distance DF14 are respectively predetermined distances for determining whether the target vehicle traffic light 400 is installed on the near side of the target intersection 200.

In particular, the thirteenth near-side distance DF13 is a predetermined distance such that, when the target vehicle traffic light 400 is installed on the near side of the target intersection 200, the target vehicle traffic light 400 is determined to be installed the thirteenth near-side distance DF13 or more on the near side from the target crossing vehicle 600, based on the position of the target crossing vehicle 600 traveling on the near side of the target intersection 200. Further, the fourteenth near-side distance DF14 is a predetermined distance such that, when the target vehicle traffic light 400 is installed on the near side of the target intersection 200, the target vehicle traffic light 400 is determined to be installed the fourteen near-side distance DF14 or more on the near side from the target crossing vehicle 600, based on the position of the target crossing vehicle 600 traveling on the far side of the target intersection 200.

In this case, as the thirteenth near-side distance DF13 and the fourteenth near-side distance DF14, the thirteenth near-side distance and the fourteenth near-side distance corresponding to the size of the target intersection 200 are selected and used from the thirteenth near-side distance and the fourteenth near-side distance for each size of the intersection stored in the storage medium of the vehicle driver assist device 10, respectively.

The thirteenth near-side distance and the fourteenth near-side distance for each size of the intersection stored in the storage medium of the vehicle driver assist device 10 are acquired by a method similar to the method or the statistical method for acquiring the seventh near-side distance described above, respectively.

When it is determined that the vehicle driver assist device 10 is “Yes” in S935, the process proceeds to S940, and as shown in FIG. 16, the position of the front from the target vehicle traffic light 400 by the fifth near-side distance DF5 is acquired as the stop line position Pstop. Next, the vehicle driver assist device 10 advances the processing to S995, and ends the processing of the routine once. Here, the vehicle driver assist device 10 executes various driver assist controls using the stop line position Pstop acquired by S940.

The fifth near-side distance DF5 is the fifth near-side distance selected according to the size of the target intersection 200 as described above.

Alternatively, in S940, the vehicle driver assist device 10 compares the position located the fifth near-side distance DF5 from the target vehicle traffic light 400 with the position located the 11th near-side distance DF11 before the target crossing vehicle 600. As a result of the comparison, the vehicle driver assist device 10 may be configured to acquire a closer position (position closer to the host vehicle 100) as the stop line position Pstop.

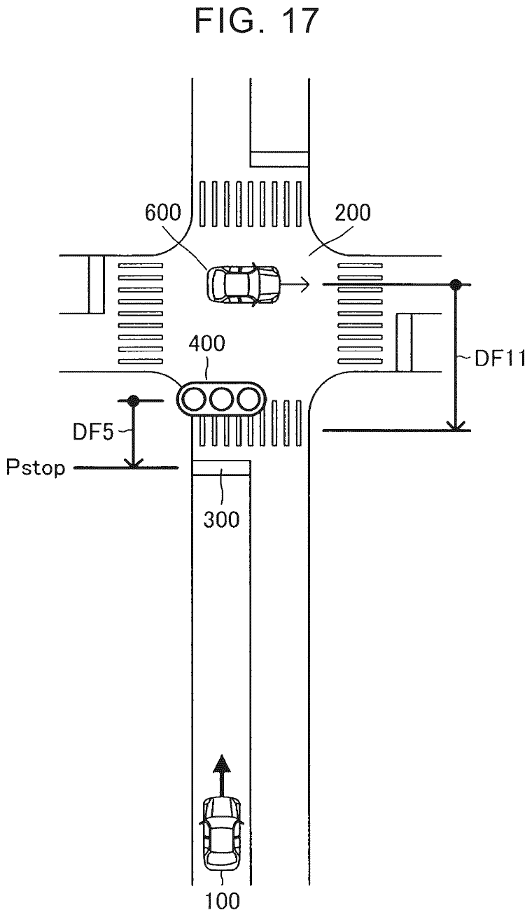

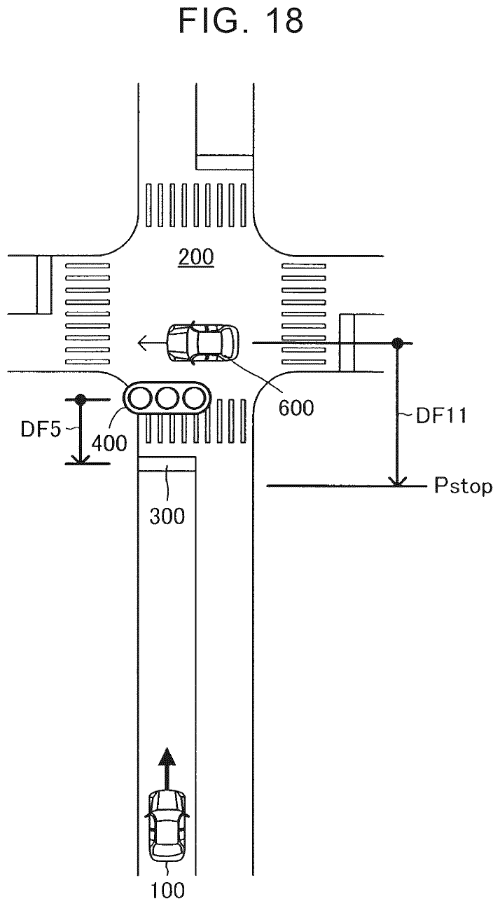

That is, as shown in FIG. 17, in the direction of travel of the host vehicle 100, than the position of the front by the 11th near-side distance DF11 from the target crossing vehicle 600, the position of the front by the fifth near-side distance DF5 from the target vehicle traffic light 400, than the position of the front (the position closer to the host vehicle 100), the position of the front by the fifth near-side distance DF5 from the target vehicle traffic light 400 may be acquired as a stop line position Pstop. As shown in FIG. 18, in the direction of travel of the host vehicle 100, than the position before only the fifth near-side distance DF5 from the target vehicle traffic light 400, the position before only the 11th front distance DF11 from the target crossing vehicle 600, if the position before the position (closer to the host vehicle 100) is, the position before only the 11th front distance DF11 from the target crossing vehicle 600 may be acquired as a stop line position Pstop.

The 11th near-side distance DF11 is the 11th near-side distance selected according to the size of the target intersection 200 as described above.

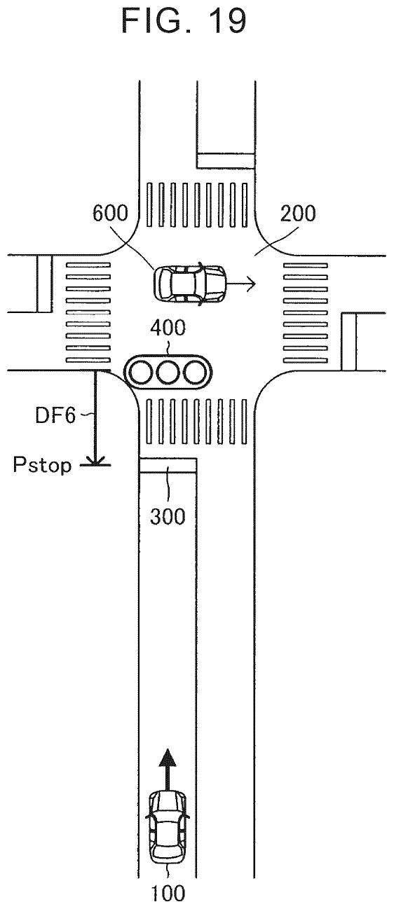

On the other hand, when it is determined that the vehicle driver assist device 10 is “No” in S935, the process proceeds to S945, and as shown in FIG. 19, the position of the front from the target vehicle traffic light 400 by the sixth near-side distance DF6 is acquired as the stop line position Pstop. The sixth near-side distance DF6 is the sixth near-side distance selected according to the size of the target intersection 200 as described above. Next, the vehicle driver assist device 10 advances the processing to S995, and ends the processing of the routine once. Here, the vehicle driver assist device 10 executes various driver assist controls using the stop line position Pstop acquired by S945.

Also, when S920 determines “No”, the vehicle driver assist device 10 advances the process to S945 and acquires the position located the sixth near-side distance DF6 before the target vehicle traffic light 400 as the stop line position Pstop. The sixth near-side distance DF6 is the sixth near-side distance selected according to the size of the target intersection 200 as described above. Next, the vehicle driver assist device 10 advances the processing to S995, and ends the processing of the routine once. The vehicle driver assist device 10 executes the driver assist control using the stopping line position Pstop acquired by S945.

When S905 determines “No”, the vehicle driver assist device 10 directly advances the processing to S995, and ends the processing of this routine once.

The above is the operation of the vehicle driver assist device 10.

According to the vehicle driver assist device 10, it is possible to estimate the position of the stop line not only when the vehicle traffic light is installed on the near side of the intersection but also when the vehicle traffic light is installed only on the far side of the intersection.

The present disclosure is not limited to the above embodiment, and various modifications can be adopted within the scope of the present disclosure.

The present disclosure is applicable to any of a vehicle that can be driven by manual driving operation and autonomous driving control, a vehicle that is driven only by manual driving operation, and a vehicle that is driven only by autonomous driving control. The manual driving operation is a driving operation that is performed by the operator to cause the vehicle to travel. The autonomous driving control is a control in which a control device such as an electronic control unit (ECU) automatically causes the vehicle to travel without the operator performing a driving operation for causing the vehicle to travel.

What is claimed is:

1. A stop line position estimation device comprising:
a detection unit for detecting a target vehicle traffic light and a target object, the target vehicle traffic light being a vehicle traffic light that is installed at a target intersection and that regulates a host vehicle, the target intersection being an intersection located in front of the host vehicle in a direction of travel of the host vehicle, and the target object being an object other than the target vehicle traffic light and having a predetermined positional relationship with the target vehicle traffic light; and
an estimation unit for estimating a position of a target stop line based on a position of the target vehicle traffic light, the target stop line being a stop line that regulates the host vehicle and that is provided on a near side of the target intersection so as to correspond to the target vehicle traffic light, wherein
the estimation unit is configured to
determine, from the positional relationship between the target object and the target vehicle traffic light, whether the target vehicle traffic light is a near-side traffic light installed on the near side of the target intersection or a far-side traffic light installed on a far side of the target intersection,
when the target vehicle traffic light is the near-side traffic light, estimate a position that is a predetermined first distance away from the near-side traffic light in a direction toward the host vehicle as the position of the target stop line, and
when the target vehicle traffic light is the far-side traffic light, estimate a position that is a predetermined second distance away from the far-side traffic light in the direction toward the host vehicle as the position of the target stop line, the predetermined second distance being greater than the predetermined first distance.

2. The stop line position estimation device according to claim 1, wherein:
the target object is a target pedestrian traffic light that is a pedestrian traffic light installed at the target intersection so as to correspond to the target vehicle traffic light;
the estimation unit is configured to
when the target vehicle traffic light is installed in a predetermined first range in the direction of travel of the host vehicle with respect to the target pedestrian traffic light, determine that the target vehicle traffic light is the far-side traffic light, and
when the target vehicle traffic light is not installed in the predetermined first range and is installed a predetermined third distance or more away from the target pedestrian traffic light in the direction toward the host vehicle, determine that the target vehicle traffic light is the near-side traffic light; and
the predetermined first range is a range from a position that is a predetermined fourth distance away from the target pedestrian traffic light in the direction toward the host vehicle to a position that is a predetermined fifth distance away from the target pedestrian traffic light in a direction away from the host vehicle.

3. The stop line position estimation device according to claim 2, wherein:
the estimation unit is configured to, when a pedestrian traffic light detected by the detection unit is installed in a predetermined second range in the direction of travel of the host vehicle with respect to the target vehicle traffic light, determine that the pedestrian traffic light is the target pedestrian traffic light; and
the predetermined second range is a range from a position that is a predetermined sixth distance away from the target vehicle traffic light in the direction toward the host vehicle to a position that is a predetermined seventh distance away from the target vehicle traffic light in the direction away from the host vehicle.

4. The stop line position estimation device according to claim 1, wherein:
the target object is a target crossing vehicle that is a crossing vehicle that passes through the target intersection and that passes through the target intersection in a direction crossing the direction of travel of the host vehicle; and
the estimation unit is configured to
when the target vehicle traffic light is installed a predetermined eighth distance or more away from the target crossing vehicle in the direction away from the host vehicle, determine that the target vehicle traffic light is the far-side traffic light, and
when the target vehicle traffic light is installed a predetermined ninth distance or more away from the target crossing vehicle in the direction toward the host vehicle, determine that the target vehicle traffic light is the near-side traffic light.
